(19) United States
(12) Patent Application Publication
(10) Pub. No.: US 2009/0060048 A1
(43) Pub. Date: Mar. 5, 2009

(54) MOTION DETECTION CIRCUIT AND METHOD

(75) Inventor: Keitaro ISHIDA, Tokyo (JP)

Correspondence Address: Studebaker & Brackett PC, 1890 Preston White Drive, Suite 105, Reston, VA, 20191, US

(73) Assignee: Oki Electric Industry Co., Ltd., Tokyo (JP)

(21) Appl. No.: 12/139,672

(22) Filed: Jun. 16, 2008

(30) Foreign Application Priority Data
Aug. 27, 2007 (JP) 2007219559

(51) Int. Cl. H04N 7/26

(52) U.S. Cl. 375/240.24; 375/E07.026

(57) ABSTRACT

A motion detection circuit calculates and updates a first Sum of Absolute Differences (SAD) between a reference macroblock stored in a reference macroblock buffer and a coding macroblock stored in a first coding macroblock buffer and calculates and updates a second SAD between a reference macroblock stored in the reference macroblock buffer and a coding macroblock stored in the second coding macroblock buffer. The motion detection circuit detects a reference macroblock, corresponding to the smallest of the updated first and second SAD values of each coding macroblock, as a predictive macroblock corresponding to the coding macroblock.

### BACKGROUND OF THE INVENTION

1. Field of the Invention

The present invention relates to a motion detection circuit and a motion detection method detect one reference macroblock of a plurality of reference macroblocks as a predictive macroblock corresponding to a coding macroblock included in an image frame, a sum of absolute differences (SAD) between pixel values of the one reference macroblock and pixel values of the coding macroblock becoming a smallest value.

2. Description of the Related Art

Moving image data is coded when the moving image data is distributed through a network or broadcast or when the moving image data is stored. One method of coding moving image data is to divide a frame for coding into macroblocks and to code a difference of each of the macroblocks from a macroblock in a reference frame. In this case, a macroblock (reference macroblock) in the reference frame having the smallest sum of absolute differences from a macroblock (coding macroblock) in the frame for coding is selected as a reference macroblock for calculation of the difference from the coding macroblock (for example, see Japanese Patent Application Publication No. 2005-244844).

One conventional apparatus detects a reference macroblock having the smallest sum of absolute differences from a coding macroblock in a pipeline fashion in order to detect the reference macroblock having the smallest sum of absolute differences at a high speed. This apparatus includes two sets of a buffer for storing a coding macroblock, a buffer for storing a reference macroblock, and a calculation circuit for calculating the sum of absolute differences, and detects a reference macroblock having the smallest sum of absolute differences from a different coding macroblock at each set. Applying this pipeline operation enables detection of a reference macroblock having the smallest sum of absolute differences from each coding macroblock at a high speed.

This conventional apparatus performs the pipeline operation using the two sets of the buffer for storing a coding macroblock, the buffer for storing a reference macroblock, and the calculation circuit for calculating the sum of absolute differences as described above. This apparatus requires a large buffer capacity for storing macroblocks since it includes multiple buffers for storing macroblocks. The buffer for storing a reference macroblock needs to store 8 moving image data, each including 10×10 pixels. To perform the pipeline operation, the apparatus needs two buffers for storing reference macroblocks. Thus, the two buffers for storing reference macroblocks require a total storage capacity of 1600 bytes in the case where a storage capacity of 8 bits is needed to store moving image data of one pixel.

To perform the pipeline operation, the buffers for storing macroblocks require a large storage capacity, thereby increasing an area on the board required for the motion detection circuit. The pipeline operation also increases power consumption for writing and reading data to and from the buffers.

### SUMMARY OF THE INVENTION

Therefore, the invention has been made in view of the above problems, and it is an object of the invention to provide a motion detection circuit and a motion detection method which can detect a reference macroblock having the smallest sum of absolute differences from a coding macroblock at a high speed by reducing the buffer capacity for storing macroblocks.

A motion detection circuit according to the invention is a circuit for detecting one reference macroblock of a plurality of reference macroblocks as a predictive macroblock corresponding to one coding macroblock having a unit area included in a frame of moving image data for coding, a sum of absolute differences (SAD) between pixel values of the one reference macroblock and pixel values of the coding macroblock becoming a smallest value, the motion detection circuit comprising: a first coding macroblock buffer and a second coding macroblock buffer which sequentially store coding macroblocks, respectively; a reference moving image storage unit which stores moving image data in a search range of motion detection of the coding macroblock; a reference macroblock buffer which reads and stores reference macroblocks for calculation of an SAD on the coding macroblock from the reference moving image storage unit; a first SAD calculator which calculates and updates a first SAD between one of the reference macroblocks stored in the reference macroblock buffer and a coding macroblock stored in the first coding macroblock buffer; a second SAD calculator which calculates and updates a second SAD between one of the reference macroblocks stored in the reference macroblock buffer and a coding macroblock stored in the second coding macroblock buffer; and a detector which detects one reference macroblock, corresponding to a smallest value of the updated first and second SAD values of each coding macroblock, as the predictive macroblock corresponding to the coding macroblock.

A motion detection method according to the invention is a method of detecting one reference macroblock of a plurality of reference macroblocks as a predictive macroblock corresponding to one coding macroblock having a unit area included in a frame of moving image data for coding, a sum of absolute differences (SAD) between pixel values of the one reference macroblock and pixel values of the coding macroblock becoming a smallest value, the motion detection method comprising the steps of: sequentially storing coding macroblocks to a first coding macroblock buffer and a second coding macroblock buffer, respectively; reading reference macroblocks for calculation of an SAD on the coding macroblock from a reference moving image storage unit and storing the read reference macroblocks to a reference macroblock buffer; calculating and updating a first SAD between one of the reference macroblocks stored in the reference macroblock buffer and a coding macroblock stored in the first coding macroblock buffer; calculating and updating a second SAD between one of the reference macroblocks stored in the reference macroblock buffer and a coding macroblock stored in the second coding macroblock buffer; and detecting one reference macroblock, corresponding to a smallest value of the updated first and second SAD values of each coding macroblock, as the predictive macroblock corresponding to the coding macroblock.

### BRIEF DESCRIPTION OF THE DRAWINGS

The above and other objects, features and other advantages of the invention will be more clearly understood from the following detailed description taken in conjunction with the accompanying drawings, in which:

FIG. 1 is a block diagram illustrating a motion detection circuit according to a first embodiment of the invention;

FIG. 2 is a block diagram illustrating a reference macroblock buffer in the motion detection circuit of FIG. 1;

FIG. 3 is a flow chart illustrating the operation of a macroblock search routine of the motion detection circuit of FIG. 1;

FIG. 4 illustrates moving image data stored in a reference moving image storage unit in the motion detection circuit of FIG. 1;

FIG. 5 illustrates example contents of a moving image buffer in the motion detection circuit of FIG. 1;

FIG. 6 illustrates how moving image data is written to the moving image buffer in the motion detection circuit of FIG. 1;

FIG. 7 illustrates how moving image data is written to the moving image buffer in the motion detection circuit of FIG. 1;

FIG. 8 is a flow chart illustrating the operation of a block search routine of the motion detection circuit of FIG. 1;

FIG. 9 illustrates example contents of the moving image buffer in the motion detection circuit of FIG. 1;

FIG. 10 illustrates a pipeline operation of the motion detection circuit of FIG. 1;

FIG. 11 is a block diagram illustrating a motion detection circuit according to a second embodiment of the invention;

FIG. 12 is a block diagram illustrating a reference macroblock buffer in the motion detection circuit of FIG. 11;

FIG. 13 is a flow chart illustrating the operation of a macroblock search routine of the motion detection circuit of FIG. 11;

FIG. 14 is a flow chart illustrating the operation of a block search routine of the motion detection circuit of FIG. 11; and

FIG. 15 illustrates a pipeline operation of the motion detection circuit of FIG. 11.

### DETAILED DESCRIPTION OF THE INVENTION

The preferred embodiments of the invention will now be described in detail with reference to the accompanying drawings.

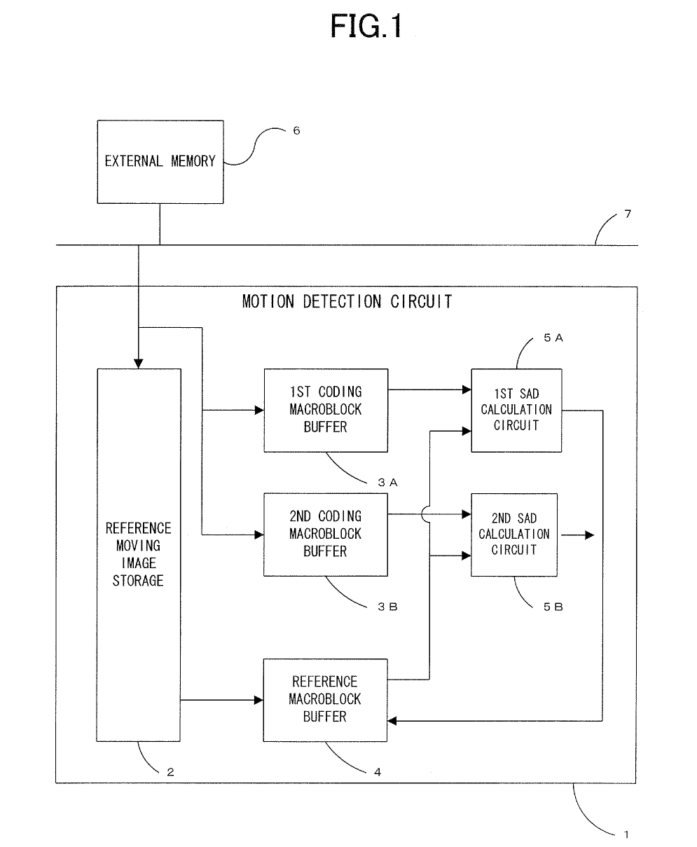

FIG. 1 illustrates a first embodiment of a motion detection circuit according to the invention. When moving image data stored in an external memory 6 connected to the motion detection circuit 1 through a bus 7 is coded, the motion detection circuit 1 performs motion detection of the moving image data stored in the external memory 6. Motion detection is to detect a reference macroblock which has pixel values provided with the smallest sum of absolute differences from pixel values of each macroblock having a unit area (hereinafter, referred to as a “coding macroblock”) included in a frame for coding. The reference macroblock is one macroblock included in a reference frame. In the following description, the sum of absolute differences will also be referred to as a “cost.”

The motion detection circuit 1 calculates costs between each coding macroblock and reference macroblocks and detects a reference macroblock having pixel values provided with the smallest cost from the coding macroblock as a predictive macroblock corresponding to the coding macroblock. The motion detection circuit 1 includes a reference moving image storage unit 2 for storing moving image data of a reference frame, first and second coding macroblock buffers 3A and 3B for storing coding macroblocks, a reference macroblock buffer 4 for storing a reference macroblock, and first and second Sum of Absolute Differences (SAD) calculation circuits 5A and 5B for calculating costs.

The reference moving image storage unit 2 reads and stores, from the reference frame, eight reference macroblocks which are centered at the same coordinates in the reference frame as those of the coding macroblock in the frame for coding. One coding macroblock is stored in each of the first and second coding macroblock buffers 3A and 3B. The first SAD calculation circuit 5A calculates a cost between a coding macroblock stored in the first coding macroblock buffer 3A and a reference macroblock stored in the reference macroblock buffer 4. The second SAD calculation circuit 5B calculates a cost between a coding macroblock stored in the second coding macroblock buffer 3B and a reference macroblock stored in the reference macroblock buffer 4.

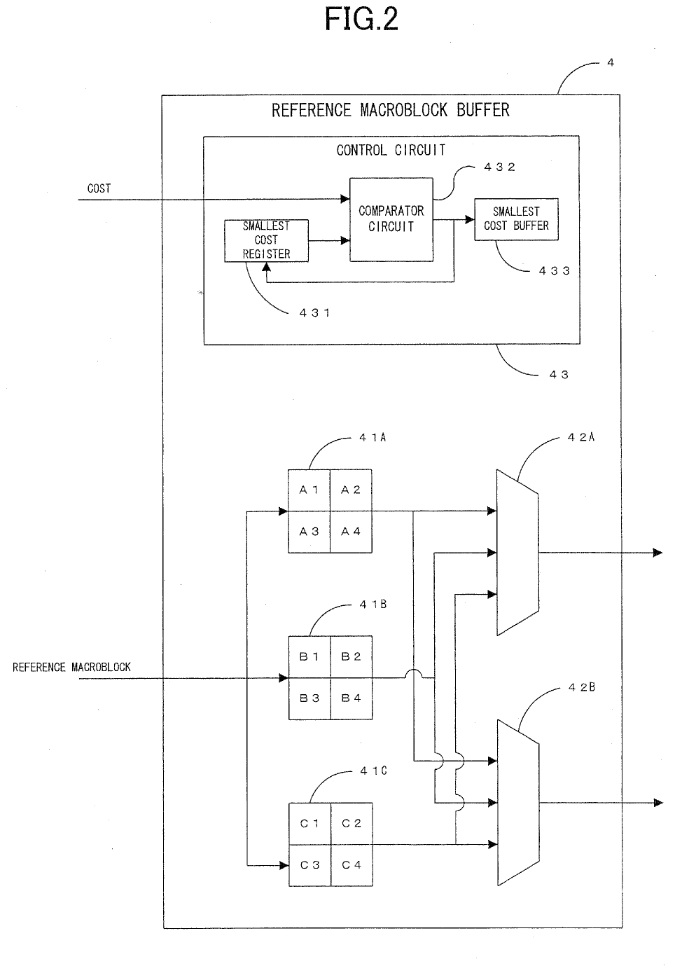

The reference macroblock buffer 4 reads and stores a reference macroblock from the reference moving image storage unit 2. FIG. 2 illustrates the configuration of the reference macroblock buffer 4. The reference macroblock buffer 4 includes moving image buffers 41A to 41C for storing moving image data, selectors 42A and 42B, and a control circuit 43. Each of the moving image buffers 41A to 41C has four moving image registers, each of which can store moving image data of 10×10 pixels around one block. Each of the moving image buffers 41A to 41C stores moving image data read from the reference moving image storage unit 2 according to a command from the control circuit 43. Each of the moving image buffers 41A to 41C also outputs the stored moving image data according to a command from the control circuit 43. The selector 42A selects moving image data output from one of the moving image buffers 41A to 41C and outputs the selected moving image data to the first SAD calculation circuit 5A according to a command from the control circuit 43. The selector 42B selects moving image data output from one of the moving image buffers 41A to 41C and outputs the selected moving image data to the second SAD calculation circuit 5B according to a command from the control circuit 43. The control circuit 43 controls the moving image buffers 41A to 41C and the selectors 42A and 42B and compares a calculated cost with a smallest cost so far. The control circuit 43 includes a smallest cost register 431 for storing smallest costs, a comparator circuit 432 for comparing calculated costs with smallest costs, and a smallest cost buffer 433 for storing information indicating one(s) of the moving image buffers 41A to 41C corresponding to each of the smallest costs. The smallest cost register 431 has 4 cost registers, each storing a smallest cost. The 4 cost registers correspond to the 4 moving image registers of each of the moving image buffers 41A to 41C. The smallest cost buffer 433 stores information indicating one(s) of the moving image buffers 41A to 41C which includes moving image registers corresponding to each of the smallest costs stored in the four cost registers of the smallest cost register 431. The comparator circuit 432 compares each of the costs stored in the 4 cost registers of the smallest cost register 431 with a calculated cost. The contents of the smallest cost register 431 and the smallest cost buffer 433 are updated according to the comparison of the comparator circuit 432.

The control circuit 43 and the first SAD calculation circuit 5A constitute a first SAD calculator of the motion detection circuit according to the invention. The control circuit 43 and the second SAD calculation circuit 5B constitute a second SAD calculator of the motion detection circuit according to the invention.

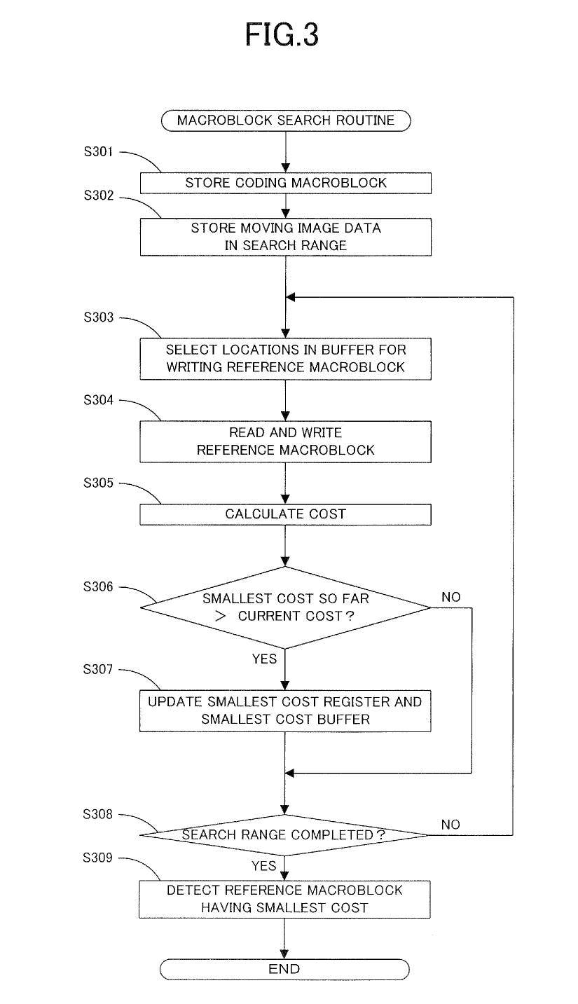

FIG. 3 illustrates the operation of a macroblock search routine for detecting a reference macroblock which has the smallest cost from a coding macroblock. The macroblock search routine is performed for a coding macroblock stored in each of the first and second coding macroblock buffers 3A and 3B.

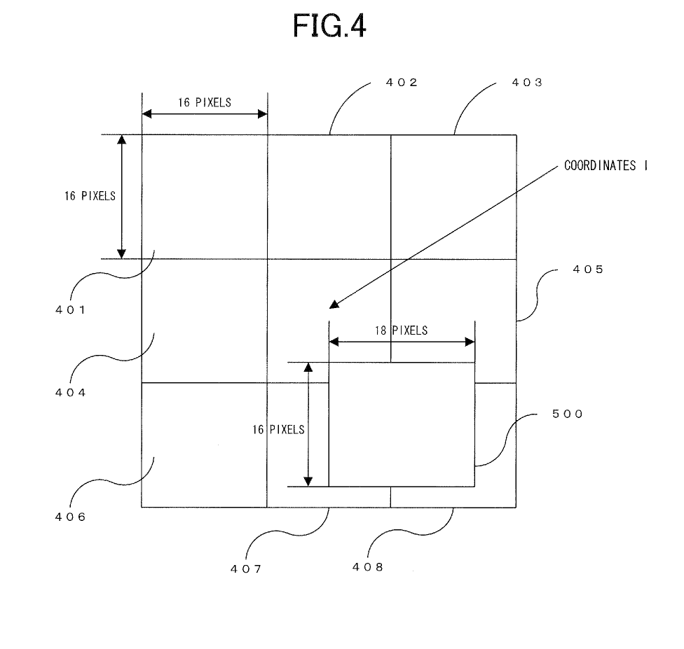

First, a coding macroblock of 16×16 pixels for motion detection is read from the external memory 6 and is then stored in the first coding macroblock buffer 3A or the second coding macroblock buffer 3B (step S301). Then, moving image data in a search range of motion detection of the coding macroblock is read from the external memory 6 and is then stored in the reference moving image storage unit 2 (step S302). When “I” represents the coordinates of the coding macroblock in the frame for coding, the moving image data in the search range of the motion detection contains 8 surrounding reference macroblocks (each including 16×16 pixels) which are centered at the coordinates I in the reference frame. The moving image data in the search range stored in the reference moving image storage unit 2 is illustrated in FIG. 4. Eight surrounding reference macroblocks 401 to 408 centered at the coordinates I are read from the reference frame and are then stored in the reference moving image storage unit 2. A read range 500 of the reference macroblocks which are stored in the reference macroblock buffer 4 after being read from the reference moving image storage unit 2 has a size of 18×16 pixels as shown in FIG. 4.

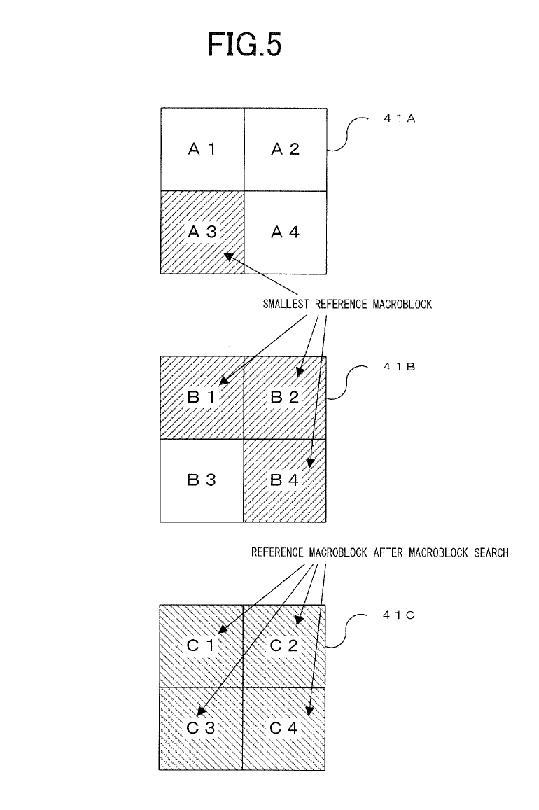

Then, locations in the reference macroblock buffer 4 for storing the reference macroblock read from the reference moving image storage unit 2 are selected (step S303). The reference macroblock buffer 4 includes 3 moving image buffers 41A to 41C. A reference macroblock, which has been finally found to have the smallest cost from a coding macroblock having coordinates I−1 immediately prior to the coordinates I through the macroblock search routine that has been completed, is stored in the moving image buffers 41A to 41C. A reference macroblock, which has been found so far to have the smallest cost from the coding macroblock of the coordinates I through the macroblock search routine that is being performed, is also stored in the moving image buffers 41A to 41C. For example, as shown in FIG. 5, the reference macroblock finally found to have the smallest cost is stored in moving image registers C1 to C4 of the moving image buffer 41C and the reference macroblock found so far to have the smallest cost is stored in a moving image register A3 of the moving image buffer 41A and moving image registers B1, B2, and B4 of the moving image buffer 41B. Locations in the reference macroblock buffer 4, where none of the reference macroblock finally found to have the smallest cost and the reference macroblock found so far to have the smallest cost are stored, are selected as storage destinations of a reference macroblock for calculation read from the reference moving image storage unit 2. For example, when the moving image buffers 41A to 41C are in the states as shown in FIG. 5, moving image registers A1, A2, and A4 of the moving image buffer 41A and a moving image register B3 of the moving image buffer 41B are selected as storage destinations of the reference macroblock read from the reference moving image storage unit 2.

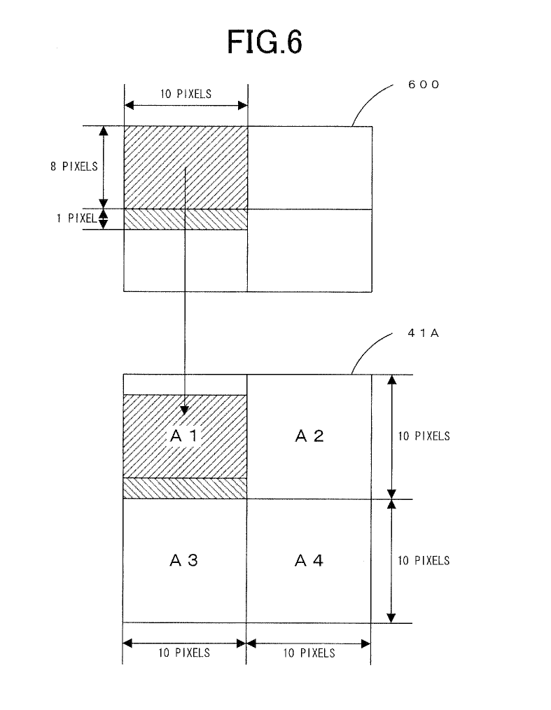

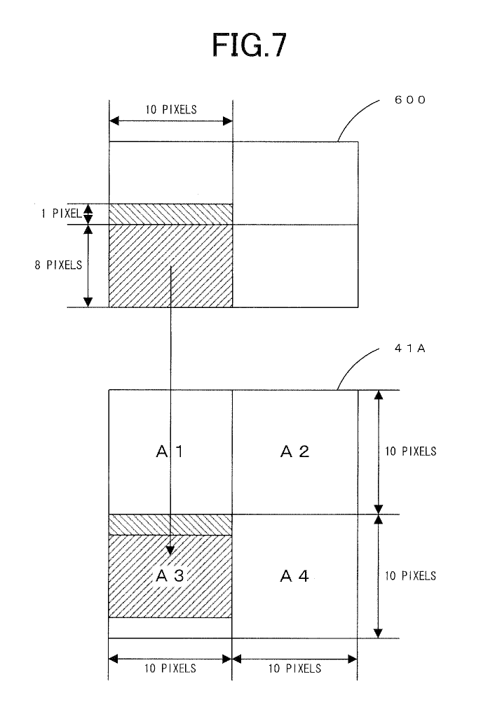

When the storage destinations of the reference macroblock read from the reference moving image storage unit 2 have been selected at step S303, the read reference macroblock is written to the selected storage destinations (step S304). FIGS. 6 and 7 illustrate how the reference macroblock is written to the moving image buffers 41A to 41C. Specifically, FIG. 6 illustrates how a left upper region of the reference macroblock is written to the register A1 of the moving image buffers 41A. More specifically, a left upper region of 10×8 pixels and a region of 10×1 pixels below the left upper region are selected from a reference macroblock 600 read from the reference moving image storage unit 2. The selected region of 10×9 pixels is written to the register A1 of the moving image buffer 41A. Writing to the register A2 of the moving image buffer 41A is performed in the same manner as the writing to the register A1 of the moving image buffer 41A. FIG. 7 illustrates how a left lower region of the reference macroblock is written to the register A3 of the moving image buffers 41A. More specifically, a left lower region of 10×8 pixels and a region of 10×1 pixels above the left lower region are selected from the reference macroblock 600 read from the reference moving image storage unit 2. The selected region of 10×9 pixels is written to the register A3 of the moving image buffer 41A. Writing to the register A4 of the moving image buffer 41A is performed in the same manner as the writing to the register A3 of the moving image buffer 41A. Writing to the other moving image buffers 41B and 41C is also performed in the same manner as the writing to the moving image buffer 41A.

After the reference macroblock is written, a cost between the written reference macroblock and a coding macroblock stored in the first coding macroblock buffer 3A or the second coding macroblock buffer 3B is calculated (step S305). For example, when the moving image buffers 41A to 41C are in the states as shown in FIG. 5, the reference macroblock read from the reference moving image storage unit 2 is written to the moving image registers A1, A2, and A4 of the moving image buffer 41A and the moving image register B3 of the moving image buffer 41B. When cost calculation is performed in this case, the moving image registers A1, A2, and A4 of the moving image buffer 41A and the moving image register B3 of the moving image buffer 41B are selected and the reference macroblock is read from the selected moving image registers. Then, a cost between the read reference macroblock and the coding macroblock is calculated. Costs are also calculated for macroblocks of 8×8 pixels, 16×8 pixels, and 8×16 pixels in addition to the macroblock of 16×16 pixel. The smallest of these costs is selected.

After the cost is calculated at step S305, the calculated cost is compared with the cost for the coding macroblock of the coordinates I which has been determined to be smallest so far through the macroblock search routine (step S306). The cost determined to be smallest so far is stored in the smallest cost register 431. The comparator circuit 432 compares the cost stored in the smallest cost register 431 with the currently calculated cost. If the comparison is that the currently calculated cost is smaller than the cost stored in the smallest cost register 431, the contents of the smallest cost register 431 and the smallest cost buffer 433 are updated (step S307).

The contents of the smallest cost register 431 are updated with the currently calculated cost. The contents of the smallest cost buffer 433 are updated with information indicating moving image registers in which the reference macroblock used to calculate the current cost is stored. On the other hand, if the comparison is that the currently calculated cost is not smaller than the cost stored in the smallest cost register 431, the contents of the smallest cost register 431 and the smallest cost buffer 433 are not updated.

Then, it is determined whether or not the calculation of the cost from the coding macroblock has been completed for all reference macroblocks in the search range of motion detection (step S308). When the cost calculation has not been completed, the reference macroblock region for reading is moved and the procedure then returns to step S303. When the cost calculation has been completed, the reference macroblock having the smallest cost is detected as a predictive macroblock (step S309). The reference macroblock having the smallest cost is stored in moving image registers indicated by the data in the smallest cost buffer 433.

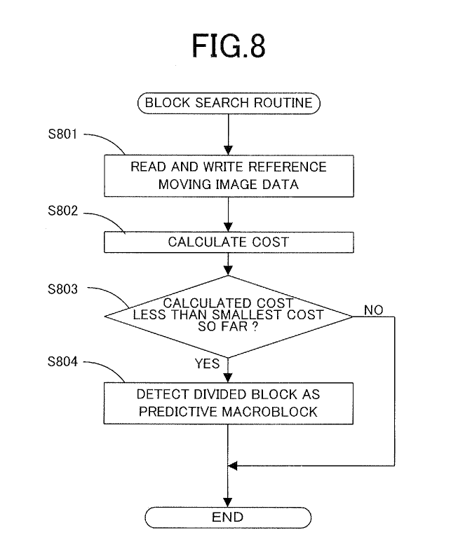

If the result of the execution of the macroblock search routine is that the reference macroblock having the smallest cost from the coding macroblock is a macroblock of 8×8 pixels, block search is performed on moving image data of 10×10 pixels around the macroblock of 8×8 pixels. FIG. 8 illustrates the operation of the block search routine.

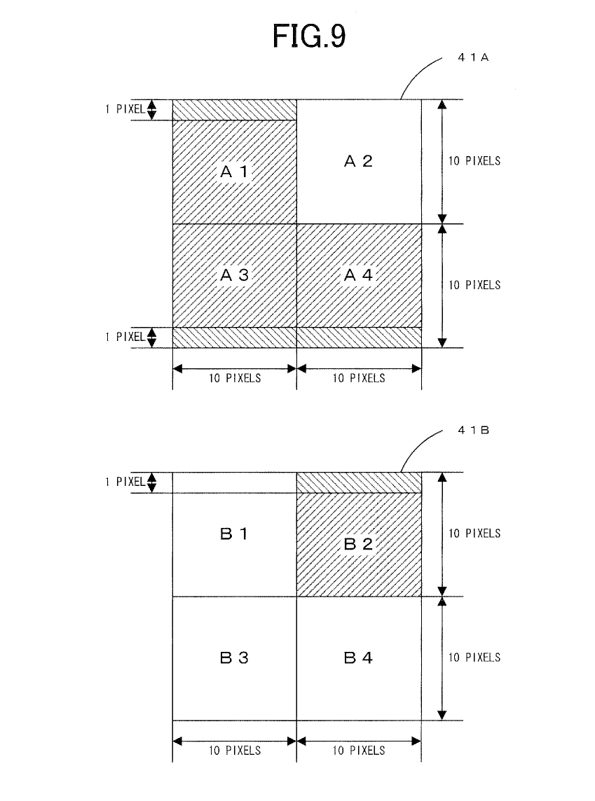

As a result of the execution of the macroblock search routine, the reference macroblock having the smallest cost from the coding macroblock is stored in moving image registers of some of the moving image buffers 41A to 41C. For example, moving image data of 10×9 pixels is stored in each of the moving image registers as shown in FIGS. 6 and 7. Since the block search is performed on moving image data of 10×10 pixels, a moving image data deficiency of 10×1 pixels is read from the reference moving image storage unit 2 and the read moving image data of 10×1 pixels is written to each moving image register (step S801). The states of these moving image registers are illustrated in FIG. 9. Here, let us assume that, as a result of the execution of the macroblock search routine, the reference macroblock having the smallest cost from the coding macroblock is stored in the moving image registers A1, A3, and A4 of the moving image buffer 41A and the moving image register B2 of the moving image buffer 41B. Moving image data of 10×9 pixels, which has been stored in each of the moving image registers when the macroblock search routine is completed, with moving image data of 10×1 pixels added thereto is stored in each of the moving image registers. The four moving image registers, which store the reference macroblock having the smallest cost from the coding macroblock, will be referred to as “moving image resisters for block search.”

After the moving image data is written, the moving image data of 10×10 pixels stored in each of the moving image resisters for block search is divided into blocks of 4×8 pixels, 8×4 pixels, and 4×4 pixels. The cost between each of the divided blocks and the coding macroblock is calculated (step S802). When the cost has been calculated, it is determined whether or not the calculated cost is less than the smallest cost so far (step S803). When the calculated cost is less than the smallest cost so far, the divided block is detected as a predictive macroblock (step S804).

The macroblock search routine and the block search routine constitute a detector of the motion detection circuit according to the invention.

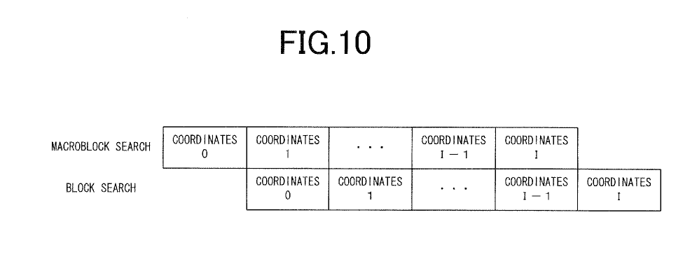

FIG. 10 illustrates how the macroblock search routine and the block search routine are executed at the motion detection circuit 1. The macroblock search routine and the block search routine are executed in a pipeline fashion. First, the macroblock search routine of a coding macroblock of coordinates 0 is executed using the first coding macroblock buffer 3A, the reference macroblock buffer 4, and the first SAD calculation circuit 5A. As a result, a reference macroblock which has the smallest cost from the coding macroblock of the coordinates 0 is stored in the reference macroblock buffer 4. After the macroblock search routine is completed, the block search routine of the coding macroblock of the coordinates 0 is executed using the first coding macroblock buffer 3A, the reference macroblock buffer 4, and the first SAD calculation circuit 5A. In parallel with the execution of the block search routine of the coding macroblock of the coordinates 0, the macroblock search routine of a coding macroblock of coordinates 1 is executed using the second coding macroblock buffer 3B, the reference macroblock buffer 4, and the second SAD calculation circuit 5B. While the macroblock search routine of the coding macroblock of the coordinates 1 is executed, a reference macroblock read from the reference moving image storage unit 2 is not written to locations where the reference macroblock having the smallest cost from the coding macroblock of the coordinates 0 is stored. Therefore, the block search routine of the coding macroblock of the coordinates 0 and the macroblock search routine of the coding macroblock of the coordinates 1 can be executed in parallel. Applying the pipeline operation in this manner enables motion detection at a high speed.

As described above, the motion detection circuit of the first embodiment executes the macroblock search routine and the block search routine in a pipeline fashion using one reference macroblock buffer 4. This makes it possible to effectively use the reference macroblock buffer 4 and to reduce the storage capacity of the reference macroblock buffer 4. Since the buffer storage capacity required to store macroblocks is reduced, it is possible to reduce an area on the board required for the motion detection circuit and to reduce power consumption for writing and reading.

It is also possible to perform motion detection at a high speed due to the pipeline operation.

Reference will now be made to a second embodiment of the invention.

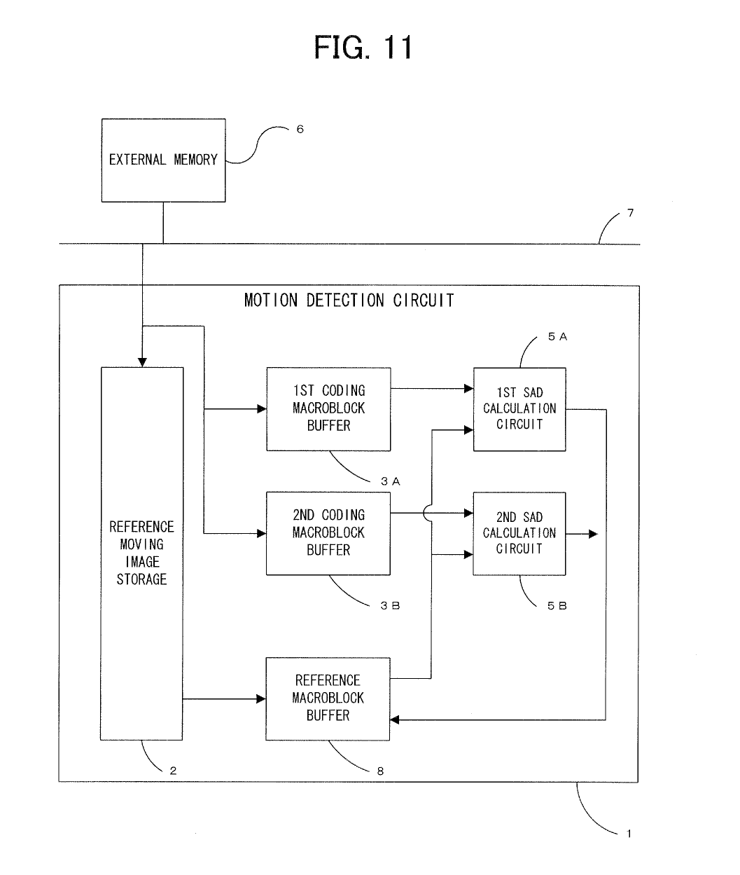

FIG. 11 illustrates the second embodiment of a motion detection circuit according to the invention. When moving image data stored in an external memory 6 connected to the motion detection circuit 1 through a bus 7 is coded, the motion detection circuit 1 performs motion detection of the moving image data stored in the external memory 6. The motion detection circuit 1 calculates costs between each coding macroblock and reference macroblocks and detects a reference macroblock having the smallest cost from the coding macroblock as a predictive macroblock corresponding to the coding macroblock. The motion detection circuit 1 includes a reference moving image storage unit 2 for storing moving image data of a reference frame, first and second coding macroblock buffers 3A and 3B for storing coding macroblocks, a reference macroblock buffer 8 for storing a reference macroblock, and first and second SAD calculation circuits 5A and 5B for calculating costs.

The reference moving image storage unit 2 reads and stores, from the reference frame, eight reference macroblocks which are centered at the same coordinates in the reference frame as those of the coding macroblock in the frame for coding. One coding macroblock is stored in each of the first and second coding macroblock buffers 3A and 3B. The first SAD calculation circuit 5A calculates a cost between a coding macroblock stored in the first coding macroblock buffer 3A and a reference macroblock stored in the reference macroblock buffer 8. The second SAD calculation circuit 5B calculates a cost between a coding macroblock stored in the second coding macroblock buffer 3B and a reference macroblock stored in the reference macroblock buffer 8.

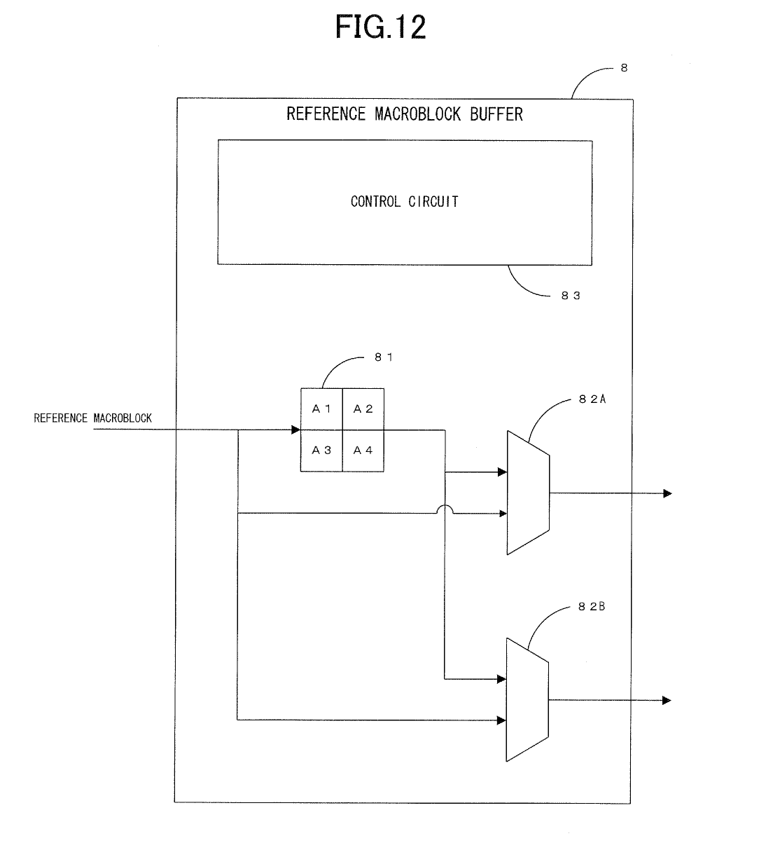

The reference macroblock buffer 8 reads and stores a reference macroblock from the reference moving image storage unit 2. FIG. 12 illustrates the configuration of the reference macroblock buffer 8. The reference macroblock buffer 8 includes a moving image buffer 81 for storing moving image data, selectors 82A and 82B, and a control circuit 83. The moving image buffer 81 has four moving image registers, each of which can store moving image data of 10×10 pixels around one block. The moving image buffer 81 stores moving image data read from the reference moving image storage unit 2 according to a command from the control circuit 83. The moving image buffer 81 also outputs the stored moving image data according to a command from the control circuit 83. The selector 82A selects either moving image data output from the moving image buffer 81 or moving image data read from the reference moving image storage unit 2 and outputs the selected moving image data to the first SAD calculation circuit 5A according to a command from the control circuit 83. The selector 82B also selects either moving image data output from the moving image buffer 81 or moving image data read from the reference moving image storage unit 2 and outputs the selected moving image data to the second SAD calculation circuit 5B according to a command from the control circuit 83. The control circuit 83 controls the moving image buffer 81 and the selectors 82A and 82B and compares a calculated cost with a smallest cost so far.

The control circuit 83 and the first SAD calculation circuit 5A constitute a first SAD calculator of the motion detection circuit according to the invention and the control circuit 83 and the second SAD calculation circuit 5B constitute a second SAD calculator. The control circuit 83 and the selector 82A constitute a first reference macroblock reader of the motion detection circuit according to the invention and the control circuit 83 and the selector 82B constitute a second reference macroblock reader.

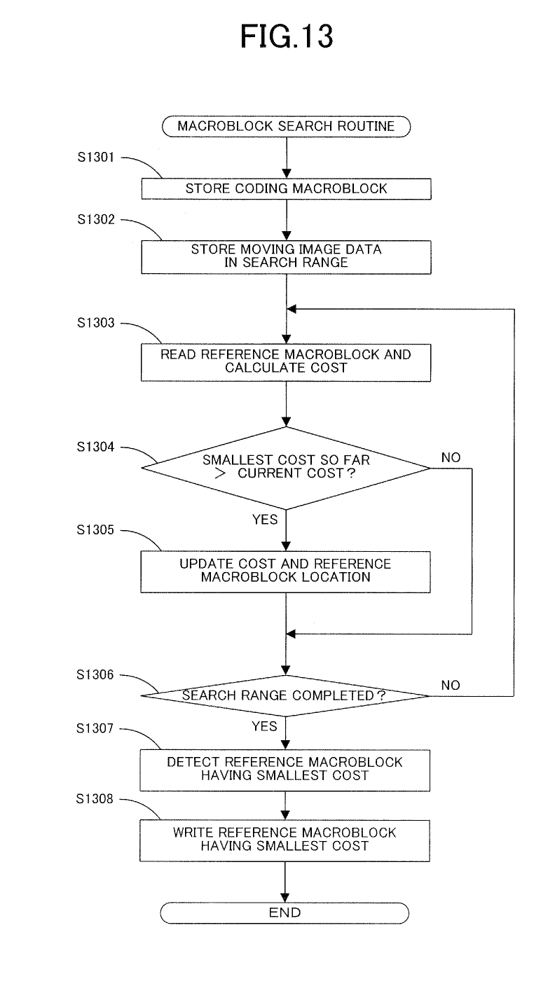

FIG. 13 illustrates the operation of a macroblock search routine for detecting a reference macroblock which has the smallest cost from a coding macroblock. The macroblock search routine is performed for a coding macroblock stored in each of the first and second coding macroblock buffers 3A and 3B.

First, a coding macroblock for motion detection is read from the external memory 6 and is then stored in the first coding macroblock buffer 3A or the second coding macroblock buffer 3B (step S1301). Then, moving image data in a search range of motion detection of the coding macroblock is read from the external memory 6 and is then stored in the reference moving image storage unit 2 (step S1302). When “I” represents the coordinates of the coding macroblock in the frame for coding, the moving image data in the search range of the motion detection contains 8 surrounding reference macroblocks which are centered at the coordinates I in the reference frame. The moving image data in the search range stored in the reference moving image storage unit 2 is illustrated in FIG. 4. Eight surrounding reference macroblocks 401 to 408 centered at the coordinates I are read from the reference frame and are then stored in the reference moving image storage unit 2. A read range 500 of the reference macroblocks which are stored in the reference macroblock buffer 8 after being read from the reference moving image storage unit 2 has a size of 18×16 pixels as shown in FIG. 4.

Then, a cost between a reference macroblock read from the reference moving image storage unit 2 and a coding macroblock stored in the first coding macroblock buffer 3A or the second coding macroblock buffer 3B is calculated (step S1303). Costs are also calculated for macroblocks of 8×8 pixels, 16×8 pixels, and 8×16 pixels in addition to the macroblock of 16×16 pixels. The smallest of these costs is selected.

After the cost is calculated at step S1305, the calculated cost is compared with the cost for the coding macroblock of the coordinates I which has been determined to be smallest so far through the macroblock search routine (step S1304). The cost determined to be smallest so far is stored in the control circuit 83. The cost stored in the control circuit 83 is compared with the currently calculated cost. If the currently calculated cost is smaller than the cost determined to be smallest so far stored in the control circuit 83, the cost stored in the control circuit 83 and information indicating the location of a reference macroblock corresponding to the stored cost are updated (step S1305).

Then, it is determined whether or not the calculation of the cost from the coding macroblock has been completed for all reference macroblocks in the search range of motion detection (step S1306). When the cost calculation has not been completed, the reference macroblock region for reading is moved and the procedure then returns to step S1303. When the cost calculation has been completed, the reference macroblock having the smallest cost is detected as a predictive macroblock (step S1307). The reference macroblock having the smallest cost is read from the reference moving image storage unit 2 and is then written to the moving image buffer 81 in the reference macroblock buffer 8. Here, moving image data of 10×10 pixels of the reference macroblock having the smallest cost including an image around the reference macroblock having the smallest cost is written to each of the four moving image registers of the moving image buffer 81.

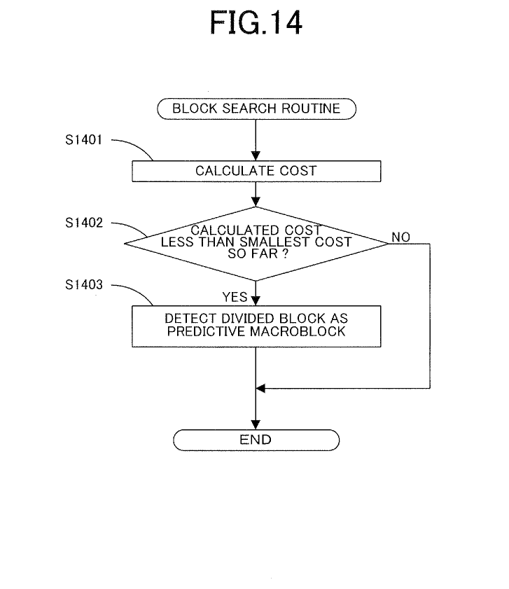

If the result of the execution of the macroblock search routine is that the reference macroblock having the smallest cost from the coding macroblock is a macroblock of 8×8 pixels, block search is performed on moving image data of 10×10 pixels around the macroblock of 8×8 pixels. FIG. 14 illustrates the operation of the block search routine.

As a result of the execution of the macroblock search routine, the reference macroblock having the smallest cost from the coding macroblock is stored in the moving image buffer 81. The moving image data of 10×10 pixels stored in each of the four moving image registers of the moving image buffer 81 is divided into blocks of 4×8 pixels, 8×4 pixels, and 4×4 pixels. The cost between each of the divided blocks and the coding macroblock is calculated (step S1401). When the cost has been calculated, it is determined whether or not the calculated cost is less than the smallest cost so far (step S1402). When the calculated cost is less than the smallest cost so far, the divided block is detected as a predictive macroblock (step S1403).

The macroblock search routine and the block search routine constitute a detector of the motion detection circuit according to the invention.

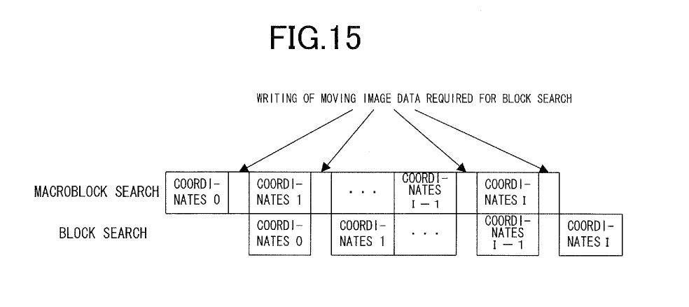

FIG. 15 illustrates how the macroblock search routine and the block search routine are executed at the motion detection circuit 1. The macroblock search routine and the block search routine are executed in a pipeline fashion. First, the macroblock search routine of a coding macroblock of coordinates 0 is executed using the first coding macroblock buffer 3A, the reference macroblock buffer 8, and the first SAD calculation circuit 5A. As a result, a reference macroblock which has the smallest cost from the coding macroblock of the coordinates 0 is stored in the reference macroblock buffer 8. After the macroblock search routine is completed, the block search routine of the coding macroblock of the coordinates 0 is executed using the first coding macroblock buffer 3A, the reference macroblock buffer 8, and the first SAD calculation circuit 5A. In parallel with the execution of the block search routine of the coding macroblock of the coordinates 0, the macroblock search routine of a coding macroblock of coordinates 1 is executed using the second coding macroblock buffer 3B, the reference macroblock buffer 8, and the second SAD calculation circuit 5B. When the macroblock search routine of the coding macroblock of the coordinates 1 is executed, moving image data in a search range of motion detection of the coding macroblock of the coordinates 1 is stored in the reference moving image storage unit 2, while the reference macroblock having the smallest cost from the coding macroblock of the coordinates 0 required to execute the block search routine is stored in the reference macroblock buffer 8. Therefore, the block search routine of the coding macroblock of the coordinates 0 and the macroblock search routine of the coding macroblock of the coordinates 1 can be executed in parallel. Applying the pipeline operation in this manner enables motion detection at a high speed.

As described above, the motion detection circuit of the second embodiment executes the macroblock search routine and the block search routine in a pipeline fashion using one reference macroblock buffer 8. The reference macroblock buffer 8 has a moving image buffer 81 including four moving image registers, each of which can store moving image data of 10×10 pixels. This can reduce the buffer storage capacity required to store macroblocks more than the motion detection circuit of the first embodiment.

Although the above description has been given of the motion detection circuit with one pixel accuracy, any motion detection circuit with accuracy lower than integer pixel accuracy can perform the same operations as those of the above embodiments.

As is apparent from the above description, the motion detection circuit of the invention has a variety of advantages. For example, the storage capacity of the reference macroblock buffer can be reduced since the reference macroblock buffer is effectively used to perform motion detection. Accordingly, it is possible to reduce an area on the board required for the motion detection circuit and to reduce power consumption for writing and reading. In addition, it is possible to perform motion detection at a high speed since the pipeline operation is performed.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

This application is based on Japanese Patent Application No. 2007-219559 which is hereby incorporated by reference.

What is claimed is:

1. A motion detection circuit for detecting one reference macroblock of a plurality of reference macroblocks as a predictive macroblock corresponding to one coding macroblock having a unit area included in a frame of moving image data for coding, a sum of absolute differences (SAD) between pixel values of the one reference macroblock and pixel values of the coding macroblock becoming a smallest value, the motion detection circuit comprising:
a first coding macroblock buffer and a second coding macroblock buffer which sequentially store coding macroblocks, respectively;
a reference moving image storage unit which stores moving image data in a search range of motion detection of the coding macroblock;
a reference macroblock buffer which reads and stores reference macroblocks for calculation of an SAD on the coding macroblock from the reference moving image storage unit;
a first SAD calculator which calculates and updates a first SAD between one of the reference macroblocks stored in the reference macroblock buffer and a coding macroblock stored in the first coding macroblock buffer;
a second SAD calculator which calculates and updates a second SAD between one of the reference macroblocks stored in the reference macroblock buffer and a coding macroblock stored in the second coding macroblock buffer; and
a detector which detects one reference macroblock, corresponding to a smallest value of the updated first and second SAD values of each coding macroblock, as the predictive macroblock corresponding to the coding macroblock.

2. The motion detection circuit according to claim 1, wherein the reference macroblock buffer stores a first reference macroblock that has been found so far to have a smallest SAD from a coding macroblock for which macroblock search is being performed, a second reference macroblock that has been finally found to have a smallest SAD from a coding macroblock for which the macroblock search has been completed, and a third reference macroblock for calculation of an SAD from a coding macroblock for which the macroblock search is being performed,
wherein, when the third reference macroblock is stored in the reference macroblock buffer after being read from the reference moving image storage unit, the third reference macroblock is stored in an area of the reference macroblock buffer where none of the first reference macroblock and the second reference macroblock are stored.

3. The motion detection circuit according to claim 2, wherein the macroblock search and detection of the predictive macroblock are executed in a pipeline fashion.

4. The motion detection circuit according to claim 1, wherein the reference macroblock buffer includes: a plurality of moving image buffers each of which stores the moving image data; a first selector which selects one of the plurality of moving image buffers and supplies the moving image data stored in the selected one moving image buffer to the first SAD calculator; a second selector which selects one of the plurality of moving image buffers and supplies the moving image data stored in the selected one moving image buffer to the second SAD calculator; and a control circuit which controls the storing operations of the plurality of moving image buffers and the selecting operations of the first and second selectors.

5. The motion detection circuit according to claim 4, wherein the control circuit includes: a smallest cost register which stores the smallest SAD values; a comparator which compares a SAD calculated by the first SAD calculator or the second SAD calculator and the smallest SAD stored in the smallest cost register; and smallest cost buffer which stores information indicating one buffer corresponding to the smallest SAD values of the plurality of moving image buffers.

6. The motion detection circuit according to claim 1, wherein the reference macroblock buffer stores a reference macroblock that has been finally found to have a smallest SAD from a coding macroblock for which macroblock search has been completed,
wherein the motion detection circuit further includes:
a first reference macroblock reader for reading a reference macroblock for calculation of an SAD from a coding macroblock stored in the first coding macroblock buffer from the reference moving image storage unit and sending the read reference macroblock for calculation to the first SAD calculator; and
a second reference macroblock reader for reading a reference macroblock for calculation of an SAD from a coding macroblock stored in the second coding macroblock buffer from the reference moving image storage unit and sending the read reference macroblock for calculation to the second SAD calculator.

7. The motion detection circuit according to claim 1, wherein the reference macroblock buffer includes: a single moving image buffer which stores the moving image data; a first selector which supplies one of the moving image data stored in the moving image buffer and the moving image data stored in the reference moving image storage unit to the first SAD calculator; a second selector which supplies one of the moving image data stored in the selected one moving image buffer and the moving image data stored in the reference moving image storage unit to the second SAD calculator; and a control circuit which controls the storing operation of the single moving image buffers and the selecting operations of the first and second selectors.

8. The motion detection circuit according to claim 1, wherein each of the first and second SAD calculators calculates a SAD for each different size in addition of an original size of the coding macroblocks and reference macroblocks to obtain the smallest SAD.

9. The motion detection circuit according to claim 8, the coding macroblocks and reference macroblocks has a size of 16×16 pixels as the original size, and SADs are calculated for macroblock sizes of 16×16 pixels, 16×8 pixels, 8×8 pixels and 8×16 pixels, respectively.

10. A motion detection method of detecting one reference macroblock of a plurality of reference macroblocks as a predictive macroblock corresponding to one coding macroblock having a unit area included in a frame of moving image data for coding, a sum of absolute differences (SAD) between pixel values of the one reference macroblock and pixel values of the coding macroblock becoming a smallest value, the motion detection method comprising the steps of:
sequentially storing coding macroblocks to a first coding macroblock buffer and a second coding macroblock buffer, respectively;
reading reference macroblocks for calculation of an SAD on the coding macroblock from a reference moving image storage unit and storing the read reference macroblocks to a reference macroblock buffer;
calculating and updating a first SAD between one of the reference macroblocks stored in the reference macroblock buffer and a coding macroblock stored in the first coding macroblock buffer;
calculating and updating a second SAD between one of the reference macroblocks stored in the reference macroblock buffer and a coding macroblock stored in the second coding macroblock buffer; and
detecting one reference macroblock, corresponding to a smallest value of the updated first and second SAD values of each coding macroblock, as the predictive macroblock corresponding to the coding macroblock.
